(19) United States
(12) Patent Application Publication
(10) Pub. No.: US 2013/0108862 A1
(43) Pub. Date: May 2, 2013

(54) Low-E Panel with Improved Layer Texturing and Method for Forming the Same

(71) Applicants: Mohd Fadzli Anwar Hassan, San Francisco, CA (US); Hien Minh Huu Le, San Jose, CA (US); Richard Blacker, Farmington Hills, MI (US); Jingyu Lao, Saline, MI (US); Yiwei Lu, Ann Harbor, MI (US)

(72) Inventors: Mohd Fadzli Anwar Hassan, San Francisco, CA (US); Hien Minh Huu Le, San Jose, CA (US); Richard Blacker, Farmington Hills, MI (US); Jingyu Lao, Saline, MI (US); Yiwei Lu, Ann Harbor, MI (US)

(21) Appl. No.: 13/282,222

(22) Filed: Oct. 26, 2011

(51) Int. Cl. B32B 15/04; B32B 15/00; B05D 5/06

(52) U.S. Cl. 428/332; 427/164; 428/457; 428/469

(57) ABSTRACT

Embodiments provided herein describe a low-e panel and a method for forming a low-e panel. A transparent substrate is provided. A metal seed layer is formed over the transparent substrate. The metal seed layer includes titanium, zirconium, hafnium, or a combination thereof. A reflective layer is formed on the metal seed layer. The metal seed layer may be continuous, or alternatively, the metal seed layer may be formed in multiple sections.

The present invention relates to low-e panels. More particularly, this invention relates to low-e panels having improved layer texturing and a method for forming such a low-e panel.

### BACKGROUND OF THE INVENTION

Low emissivity, or low-e, panels are often formed by depositing a reflective layer (e.g., silver) onto a substrate, such as glass. The overall quality of the reflective layer, such as with respect to texturing and crystallographic orientation, is important for achieving the desired performance, such as high visible light transmission and low emissivity (i.e., high heat reflection).

One known method to achieve low emissivity is to form a relatively thick silver layer. However, as the thickness of the silver layer increases, the visible light transmission of the reflective layer is reduced, as is manufacturing throughput, while overall manufacturing costs are increased. Therefore, is it desirable to form the silver layer as thin as possible, while still providing emissivity that is suitable for low-e applications.

### BRIEF DESCRIPTION OF THE DRAWINGS

Various embodiments of the invention are disclosed in the following detailed description and the accompanying drawings:

FIG. 1 is a cross-sectional side view of a low-e panel according to one embodiment of the present invention;

FIG. 2 is a cross-sectional plan view of the low-e panel taken along line 2-2 in FIG. 1, according to one embodiment of the present invention;

FIG. 3 is a cross-sectional plan view of the low-e panel taken along line 2-2 in FIG. 1, according to another embodiment of the present invention;

FIG. 4 is a simplified cross-sectional diagram illustrating a physical vapor deposition (PVD) tool according to one embodiment of the present invention;

FIG. 5 is a cross-sectional schematic of a portion of the PVD tool of FIG. 4 and a processing fluid system.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Generally, embodiments described herein provide methods for forming a low-e panel in such a way to improve the overall quality of the reflective layer (e.g., silver), particularly with respect to texturing, as well as thickness. More specifically, the methods allow for improved texturing of the reflective layer such that the thickness of the reflective layer may be reduced while still providing desirably low emissivity. In one embodiment, this is accomplished by forming relatively thin (e.g., up to 50 Angstroms (Å)) “seed” layer of, for example, substantially pure titanium, zirconium, and/or hafnium in the stack, onto which the reflective layer is formed.

Generally, it is preferable to form the reflective layer in such a way that visible light transmission is high and emissivity is low. It is also preferable to maximize volume production, throughput, and efficiency of the manufacturing process used to form low-e panels.

Forming the reflective layer on the seed layer described herein promotes growth of the reflective layer in a <111> crystallographic orientation when the reflective layer is silver. The silver <111> orientation is preferable for low-e panel applications because it allows for the reflective layer to have relatively high electrical conductivity, and thus relatively low sheet resistance (Rₛ). Low sheet resistance is preferred because sheet resistance is proportionally related to emissivity.

For example, in one embodiment, a transparent substrate is first provided. A metal seed layer is formed over the transparent substrate (and perhaps other layers). The metal seed layer is made of titanium, zirconium, hafnium, or a combination thereof. The reflective layer (e.g., silver) is then formed on (i.e., in contact with) the metal seed layer.

Generally, seed layers are relatively thin layers of materials formed on a surface (e.g., a substrate) to promote a particular characteristic of a subsequent layer formed over the surface (e.g., on the seed layer). For example, seed layers may be used to improve adhesion between the subsequent layer and the substrate or increase the rate at which the subsequent layer is grown on the substrate during the respective deposition process.

However, seed layers may also be used to affect the crystalline structure (or crystallographic orientation) of the subsequent layer, which is sometimes referred to as “templating.” More particularly, the interaction of the material of the subsequent layer with the crystalline structure of the seed layer causes the crystalline structure of the subsequent layer to be formed in a particular orientation.

According to one aspect of the present invention, a metal seed layer is used to promote growth of the reflective layer in a particular crystallographic orientation. In a particular embodiment, the metal seed layer is a material with a hexagonal crystal structure and is formed with a <002> crystallographic orientation which promotes growth of the reflective layer in the <111> orientation when the reflective layer has a face centered cubic crystal structure (e.g., silver), which is preferable for low-e panel applications.

Other layers in the stack may include a nitride layer formed on the transparent substrate and a metal oxide layer (e.g., zinc oxide) formed on the nitride. The metal seed layer is formed over (e.g., on) the metal oxide layer. Additionally, the metal seed layer need not be completely continuous. That is, in some embodiments, the metal seed layer may be formed in laterally spaced sections or portions, which do not completely cover the metal oxide layer. In such an embodiment, the metal seed layer may have a thickness of, for example, between 2.0 and 4.0 Å.

In addition to improving the texturing of the reflective layer, as described in more detail below, the metal seed layer remains in place and retains its metallic composition after the reflective layer is formed. Thus, the metal seed layer forms a barrier between the metal oxide and the reflective layer, which helps reduce any reaction between the silver in the reflective layer and the oxygen in the metal oxide by providing a substantially pure metal layer that does not include any oxygen. As a result, the resistivity of the reflective layer remains low, thus improving its emissivity.

Further, because of the improvement in resistivity, a thinner layer of the reflective layer may now be formed while still providing the desired performance with respect to emissivity. As a result, the transmission of visible light through the stack is improved and/or increased.

According to one embodiment, a method for forming a low-e panel is provided. A transparent substrate is provided. A metal seed layer is formed over the transparent substrate. The metal seed layer includes titanium, zirconium, hafnium, or a combination thereof. A reflective layer is formed on the metal seed layer. The reflective layer may be in contact with the metal seed layer.

A metal oxide layer may also be formed over the transparent substrate, with the metal seed layer being formed over the metal oxide layer. The metal seed layer may be in contact with the metal oxide layer.

The metal seed layer may include a plurality of layer sections, with each of the metal seed layer sections being laterally spaced apart from the other layer sections. The metal seed layer may have a thickness of 50 Å or less. The reflective layer may include silver.

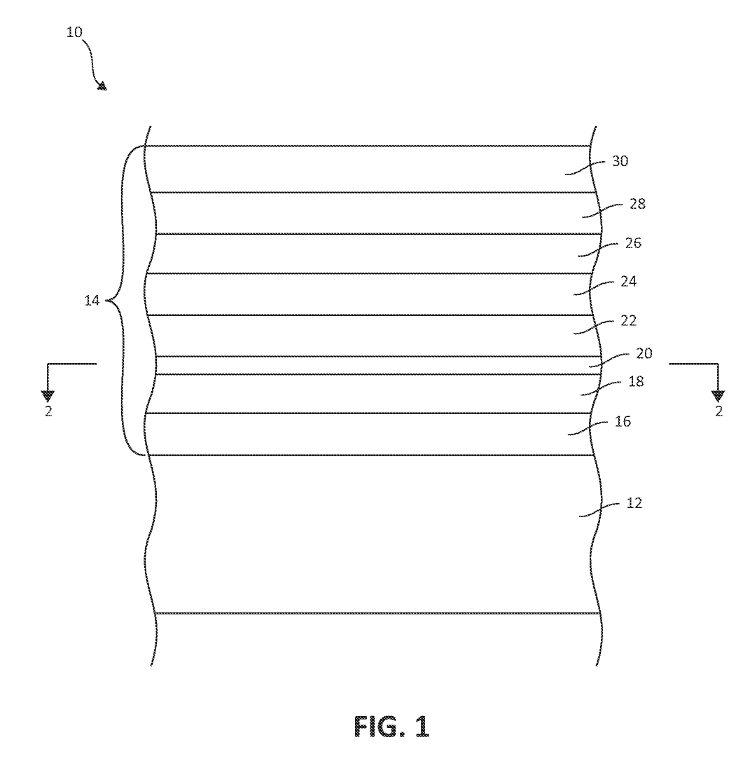

FIG. 1 illustrates a low-e panel 10 according to one embodiment of the present invention. The low-e panel 10 includes a transparent substrate 12 and a low-e stack 14 formed over the transparent substrate 12. The transparent substrate 12 in one embodiment is made of a low emissivity glass, such as borosilicate glass, and has a thickness of, for example, between 1 and 10 millimeters (mm). In a testing environment, the transparent substrate 12 may be round with a diameter of, for example, 200 or 300 mm. However, in a manufacturing environment, the substrate 12 may be square or rectangular and significantly larger (e.g., 0.5-3 meters (m) across). In other embodiments, the substrate 12 may be made of, for example, plastic or polycarbonate.

The low-e stack 14 includes a lower protective layer 16, a lower metal oxide layer 18, a seed layer 20, a reflective layer 22, a metal alloy layer 24, an upper metal oxide layer 26, an optical filler layer 28, and an upper protective layer 30. Exemplary details as to the functionality provided by each of the layers 16-30 are provided below.

The various layers in the low-e stack 14 may be formed sequentially (i.e., from bottom to top) on the substrate 12 using a reactive physical vapor deposition (PVD) and/or reactive sputtering processing tool. In one embodiment, the low-e stack 14 is formed over the entire substrate 12. However, in other embodiments, the low-e stack 14 may only be formed on isolated portions of the substrate 12.

Still referring to FIG. 1, the lower protective layer 16 is formed on the upper surface of the substrate 12. In one embodiment, the lower protective layer 16 is made of silicon nitride and has a thickness of, for example, 250 Angstroms (Å). The lower protective layer 16 may protect the other layers in the stack 14 from diffusion from the substrate 12 and may be used to tune the optical properties (e.g., transmission) of the stack 14.

The lower metal oxide layer 18 is formed over the substrate 12 and on the lower protective layer 16. In one embodiment, the lower metal oxide layer 18 is made of as zinc oxide and has a thickness of, for example, 100 Å. The lower metal oxide layer 18 may enhance the texturing of the reflective layer 22, as is described in greater detail below, and increase the transmission of the stack 14 for anti-reflection purposes.

Of particular interest in FIG. 1 is the seed layer 20. In one embodiment, the seed layer 20 is made of a metal, such as titanium, zirconium, and/or hafnium, and has a thickness of, for example, 50 Å or less.

In one embodiment, the metal seed layer 20 is made of titanium. However, it should be noted that the metal seed layer 20 may also be made of zirconium or hafnium, which have atomic radii and crystal structures similar to that of titanium.

The seed layer 20 may be deposited using “hot” or “cold” sputtering, as is commonly understood. In one embodiment, the seed layer is formed using a hot sputtering process, in which the substrate 12 is heated to a temperature greater than 100° C. (i.e., during the formation of the seed layer 20) in order to promote a <002> crystallographic orientation in the material of the seed layer 20. In one embodiment, more than 30% of the seed layer 20 has a <002> crystallographic orientation, as determined by X-ray diffraction (XRD), which promotes growth of the reflective layer 22 in a <111> orientation, as described below.

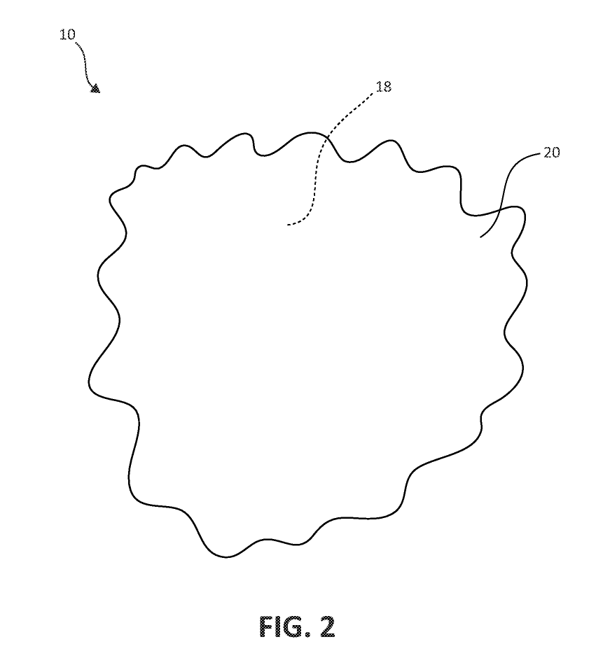

In the embodiment shown in FIGS. 1 and 2, the seed layer 20 is continuous and covers, and is in contact with, the entire lower metal oxide layer 18 (or at least the portion of the lower metal oxide layer 18 shown). However, in other embodiments, the seed layer 20 may not be formed in a completely continuous manner.

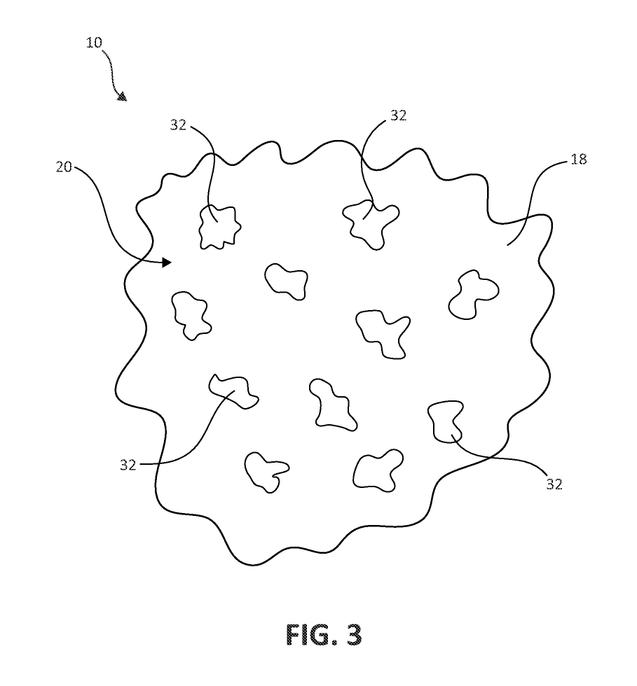

An example of such an embodiment is shown in FIG. 3, where the seed layer 20 includes, or is made of, a plurality of seed layer sections or portions 32. The seed layer sections 32 are distributed across the lower metal oxide layer 18 such that each of the seed layer sections 32 is laterally spaced apart from the other seed layer sections 32 across the lower metal oxide layer 18 and do not completely cover the lower metal oxide layer 18. In such an embodiment, the seed layer 20 and/or the layer sections 32 may have a thickness of, for example, between 2.0 and 4.0 Å, and the separation between the layer sections 32 may be the result of forming such a thin seed layer (i.e., such a thin layer may not form a continuous layer).

Additionally, it should be understood that a continuous seed layer 20 may be considered to include a plurality of seed layer sections 32 formed in such proximity that the seed layer sections 32 are contiguous (i.e., not spaced apart). Further, it should be understood that the seed layer 20 with the individual seed layer sections 32 shown in FIG. 3 may represent a state of a continuous seed layer 20 during the formation thereof, before the desired thickness (e.g., 50 Å) is achieved. That is, the seed layer sections 32 may form during the initial deposition of the seed layer 20, and may subsequent “grow” together to form a continuous seed layer 20.

Referring again to FIG. 1, in the depicted embodiment, the reflective layer 22 is formed on, and in contact with, the seed layer 20. In one embodiment, the reflective layer 22 is made of silver and has a thickness of, for example, 100 Å. In an embodiment in which the seed layer 20 is deposited using hot sputtering, the reflective layer 20 is deposited after the seed layer 20 has sufficiently cooled (e.g., to a temperature that is less than 70° C.).

Of particular interest is that because the reflective layer 22 is formed on and in contact with the seed layer 20, due to the <002> crystallographic orientation of the seed layer 20, growth of the reflective layer 22 in a <111> texturing orientation is be promoted. Growth in the <111> may be promoted even in embodiments in which the seed layer 20 includes separate seed layer sections 32 (FIG. 3).

As will be appreciated by one skilled in the art, the promoted growth of the reflective layer 22 in the <111> crystallographic orientation is caused by the interaction between the crystalline structure of the seed layer 20 and the material of the reflective layer 22. More particularly, the material of the seed layer 20 has a hexagonal crystalline structure, which may promote the metal deposited thereon to grow in a <111> crystallographic orientation. In one embodiment, more than 30% of the reflective layer 22 has a <111> crystallographic orientation, as determined by XRD.

Additionally, because the seed layer 20 is positioned between the lower metal oxide layer 18 and the reflective layer 22, the seed layer 20 serves as a barrier (e.g., a substantially pure metal) between the metal oxide of the lower metal oxide layer 18 and the reflective layer 22 such that any oxidation of the reflective layer 22, such as during a subsequent heating process, is reduced.

Still referring to FIG. 1, the metal alloy layer 24 and the upper metal oxide layer 26 are formed over the reflective layer 20. In one embodiment, the metal alloy layer 24 is made of nickel-chromium and has a thickness of, for example, 30 Å. The metal alloy layer 24 may prevent the reflective layer 22 from oxidizing and protect the reflective layer 22 during subsequent processing steps, such as heating.

The upper metal oxide layer 26 is formed on the metal alloy layer 24. In one embodiment, the upper metal oxide layer 26 includes the metal alloy of the metal alloy layer 24 (e.g., nickel-chromium oxide) and has a thickness of, for example, 30 Å. The upper metal oxide layer 26 may provide adhesion between the reflective layer 22 and the optical filler layer 28, as well as the upper protective layer 30.

The optical filler layer 28 is formed on the upper metal oxide layer 26. In one embodiment, the optical filler layer 28 is made of tin oxide and has a thickness of, for example, 100 Å. The optical filler layer 28 may be used to tune the optical properties of the low-e panel 10. For example, the thickness and refractive index of the optical filler layer 28 may be used to increase or decrease the visible light transmission of the stack 14, or the panel 12 as a whole.

Still referring to FIG. 1, the upper protective layer 30 is formed on the optical filler layer 28. In one embodiment, the upper protective layer 28 is made of silicon nitride and has a thickness of, for example, 250 Å. In one embodiment, the upper protective layer 30 is used to protect the lower layers of the stack 14 and further adjust the optical properties of the stack 14.

Because of the promoted <111> texturing orientation of the reflective layer 22 caused by the seed layer 20, the conductivity and emissivity of the reflective layer 22 is improved. As a result, a thinner reflective layer 22 may be formed that still provides sufficient reflective properties and visible light transmission. Additionally, the reduced thickness of the reflective layer 22 allows for less material to be used in each panel that is manufactured, thus improving manufacturing throughput and efficiency, increasing the usable life of the target (e.g., silver) used to form the reflective layer 22, and reducing overall manufacturing costs.

Further, the seed layer 20 provides a barrier between the metal oxide of the lower metal oxide layer 18 and the reflective layer 22 to reduce the likelihood of any reaction of the material of the reflective layer 22 and the oxygen in the lower metal oxide layer 18, especially during subsequent heating processes. As a result, the resistivity of the reflective layer 22 may be reduced, thus increasing performance of the reflective layer 22 by lowering the emissivity.

Thus, in one embodiment, a method for forming a low-e panel is provided. A transparent substrate is provided. A metal seed layer is formed over the transparent substrate. The metal seed layer includes titanium, zirconium, hafnium, or a combination thereof. More than 30% of the metal seed layer has a <002> crystallographic orientation A temperature of the substrate may be at least 100° C. during the formation of the metal seed layer. A reflective layer is formed on the metal seed layer.

In another embodiment, a low-e panel is provided. The low-e panel includes a transparent substrate. A metal seed layer is formed over the transparent substrate. The metal seed layer comprises titanium, zirconium, hafnium, or a combination thereof. More than 30% of the metal seed layer has a <002> crystallographic orientation. A temperature of the substrate may be at least 100° C. during the formation of the metal seed layer. A reflective layer is formed on and in contact with the metal seed layer.

In a further embodiment, a method for constructing a low-e panel is provided. A transparent substrate is provided. A hafnium layer is formed over the transparent substrate. More than 30% of the hafnium layer has a <002> crystallographic orientation. A reflective layer is formed over and in contact with the hafnium layer.

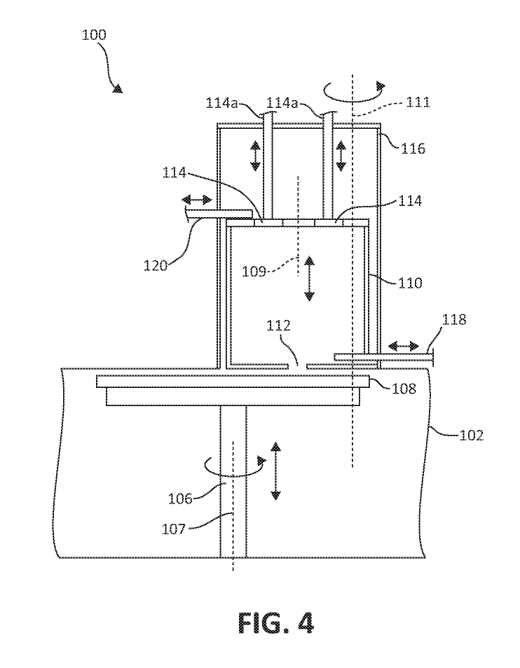

FIG. 4 provides a simplified illustration of a physical vapor deposition (PVD) tool (and/or processing chamber and/or system) 100 which may be used to formed the low-e panel 10 described above, in accordance with one embodiment of the invention. It should be noted that the PVD tool 100 described herein may be suitable for “combinatorially” processing a substrate in a testing environment such that variations are intentionally formed across different regions of the substrate. However, in other embodiments (such as in a manufacturing environment), more conventional PVD tools may be used to uniformly process the substrate.

The PVD tool 100 shown in FIG. 4 includes a bottom chamber portion 102 disposed under a top chamber portion 116. Within the bottom chamber portion 102, a substrate support 106 is configured to hold a substrate 108 and may be any known substrate support, including but not limited to a vacuum chuck, electrostatic chuck, or other known mechanisms. The substrate support 106 is capable of rotating around a central axis 107 thereof that is perpendicular to the surface of the substrate 108. In addition, the substrate support 106 may move in a vertical direction or in a planar direction. It should be appreciated that the rotation and movement in the vertical direction or planar direction may be achieved through known drive mechanisms which include magnetic drives, linear drives, worm screws, lead screws, a differentially pumped rotary feed through drive, etc.

The substrate 108 may be a round transparent (e.g., borosilicate glass) substrate having a diameter of, for example, 200 or 300 mm. In other embodiments (such as in a manufacturing environment), the substrate 108 may have other shapes, such as square or rectangular, and may be significantly larger (e.g., 0.5-3 meters (m) across).

The top chamber portion 116 of the PVD tool 100 includes a process kit shield 110, which defines a confinement region over a radial portion of substrate 108. The process kit shield 110 is essentially a sleeve having a base (optionally integral with the shield) and an optional top within chamber 100 that may be used to confine a plasma generated therein used for physical vapor deposition (PVD) or other flux based processing. The generated plasma will dislodge particles from a target to process (e.g., be deposited) on an exposed surface of the substrate 108 to process regions of the substrate in one embodiment.

The base (or base plate) of process kit shield 110 includes an aperture 112 through which a portion of a surface of the substrate 108 is exposed for deposition or some other suitable semiconductor processing operation. Within the top portion 116, a cover plate 118 is moveably disposed over the base of process kit shield 110. In one embodiment, the cover plate 118 may slide across a bottom surface of the base of process kit shield 110 in order to cover or expose the aperture 112.

The optional top plate of sleeve 110 of FIG. 4 may function as a datum shield. Process heads 114 (also referred to as deposition guns) are disposed within slots defined within the datum shield in accordance with one embodiment of the invention. In the depicted embodiment, a datum shield slide cover plate 120 is included and functions to seal off one or more of the process heads 114 (or deposition guns) when not in use.

Although only two process heads 114 are shown in FIG. 4, it should be understood that the PVD tool 100 may include more, such as three, four, or more process heads, each of which includes a target, as described below. The multiple process heads may be referred to as a cluster of process heads 114. The process heads 114 are moveable in a vertical direction so that one or both may be lifted from the slots of the datum shield (i.e., the top portion of sleeve 110). In addition, the cluster of process heads 114 may be rotatable around an axis 109.

When the process heads 114 are lifted, the slide cover plate 120 may be transitioned to isolate the lifted process heads from the processing area defined within the process kit shield 110. As such, the process heads 114 may be selectively isolated from certain processes.

The cluster of process heads 114 enables co-sputtering of different materials onto the substrate 108, as well as a single material being deposited and various other processes. Accordingly, numerous combinations of target materials, multiple deposition guns having the same material, or any combination thereof may be applied to the different regions of the substrate so that an array of differently processed regions results.

Still referring to FIG. 4, the top section 116 of the PVD tool 100 includes sidewalls and a top plate which house process kit shield 110. Arm extensions 114a, each of which is attached to one of the process heads 114, extend through an upper end of the top portion 116. The arm extensions 114a may be attached to a suitable drive (or actuator), such as lead screws, worm gears, etc., which are configured to vertically move the process heads 114 relative to the top portion 116. The arm extensions 114a may be pivotably affixed to the process heads 114 to enable the process heads to tilt relative to a vertical axis (e.g., axis 107).

As indicated in FIG. 4, the process kit shield 110 is moveable in a vertical direction and is configured to rotate around an axis 111. It should be appreciated that the axis 111 around which process kit shield 110 rotates is offset from both the axis 107 about which the substrate support 106 rotates and the axis 109 of the cluster of process heads 114. As such, a plurality of regions on the substrate 108 may be exposed for combinatorial processing, by rotating the substrate 108, the cluster of process heads 114, and the process kit shield 110 between various angular positions.

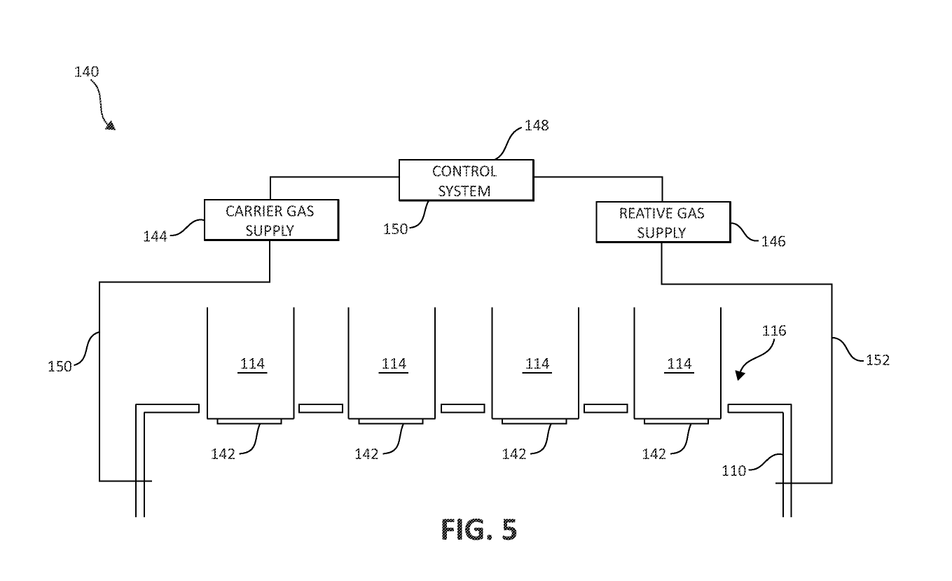

FIG. 5 schematically illustrates a section of the top chamber portion 116 of the PVD tool 100, along with a processing fluid system 140. A cluster of four process heads 114 is shown, for clarity, arranged in a linear manner. However, as described above, the process heads 114 may be arranged about an axis (i.e., axis 109 in FIG. 4), as indicated by the arrangement of the arm extensions 114 a shown in FIG. 4. It should be noted that although all four process heads 114 are shown as being inserted into the slots in the top portion of the process kit shield 110, one or more of them may be lifted and isolated (i.e., by the slide cover plate 120 in FIG. 4) during processing.

As described above, each of the process heads 114 includes a target 142 made of the material (or materials) to be deposited on the substrate 108 (FIG. 4). As such, the materials used in the targets 142 of the process heads 114 may include silicon, zinc, titanium, zirconium, hafnium, silver, nickel, chromium, or a combination thereof (e.g., a single target may include a nickel chromium alloy). Although not specifically shown, the targets 142 are connected to a power supply, as is the substrate support 106 (FIG. 4).

The processing fluid system 140 includes a carrier gas supply (or supplies) 144, a reactive gas supply (or supplies) 146, and a control system 148. The carrier gas supply 144 includes one or more supplies of suitable carrier gases for PVD processing, such as argon, krypton, or a combination thereof. The reactive gas supply 146 includes one of more supplies of suitable reactive gases for forming various oxides and nitrides with PVD processing, such as oxygen, nitrogen, or a combination thereof.

The control system 148 includes, for example, a processor and a memory (i.e., a computing system) in operable communication with the carrier gas supply 144 and the reactive gas supply 146 and configured to control the flow of carrier and reactive gases to the process heads 114. Still referring to FIG. 5, a carrier gas line (or conduit) 150 and a reactive gas line 152 are provided for delivering a carrier gas from the carrier gas supply 144 to the targets 142.

In operation, particles are ejected from the various targets 142 and deposited onto the substrate 108 (FIG. 4) to form the various layers shown in FIG. 1. During the formation of layers (e.g., the seed layer 20), the ejected particles only pass through a suitable inert carrier gas, such as argon. However, during the formation of, for example, the protective layers 16 and 30 and the metal oxide layers 18 and 26, suitable reactive gasses are provided, such as nitrogen and oxygen.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming a low-e panel comprising:
providing a transparent substrate;
forming a metal seed layer over the transparent substrate, wherein the metal seed layer comprises one of titanium, zirconium, hafnium, or a combination thereof, and wherein more than 30% of the metal seed layer has a <002> crystallographic orientation; and
forming a reflective layer on the metal seed layer.

2. The method of claim 1, wherein a temperature of the transparent substrate is at least 100° C. during the formation of the metal seed layer.

3. The method of claim 1, wherein the metal seed layer is a hafnium layer.

4. The method of claim 1, wherein the reflective layer is in contact with the metal seed layer, and further comprising forming a metal oxide layer over the transparent substrate, wherein the metal seed layer is formed over the metal oxide layer.

5. The method of claim 1, wherein the metal seed layer comprises a plurality of sections of a layer, each of the plurality of sections of the layer being spaced apart from the others of the plurality of sections of the layer.

6. The method of claim 1, wherein the metal seed layer has a thickness 50 Å or less.

7. The method of claim 1, wherein the reflective layer comprises silver.

8. The method of claim 4, wherein the metal oxide layer comprises zinc.

9. The method of claim 4, further comprising forming a nitride layer over the transparent substrate, wherein the metal oxide layer is formed over the nitride layer.

10. The method of claim 1, further comprising forming a metal alloy layer over the reflective layer.

11. A low-e panel comprising:
a transparent substrate;
a metal seed layer formed over the transparent substrate, wherein the metal seed layer comprises one of titanium, zirconium, hafnium, or a combination thereof, and wherein more than 30% of the metal seed layer has a <002> crystallographic orientation; and
a reflective layer formed on and in contact with the metal seed layer.

12. The low-e panel of claim 11, wherein the metal seed layer is a hafnium layer.

13. The low-e panel of claim 11, further comprising a metal oxide layer formed over the transparent substrate.

14. The low-e panel of claim 12, wherein the metal seed layer has a thickness of 50 Å or less.

15. The low-e panel of claim 11, wherein the reflective layer comprises silver.

16. A method for constructing a low-e panel comprising:
providing a transparent substrate;
forming a hafnium layer over the transparent substrate, wherein more than 30% of the hafnium layer has a <002> crystallographic orientation; and
forming a reflective layer over and in contact with the hafnium layer.

17. The method of claim 16, further comprising heating the transparent substrate such that a temperature of the transparent substrate is at least 100° C. during the formation of the hafnium layer.

18. The method of claim 16, further comprising forming a metal oxide layer over the transparent substrate, wherein the hafnium layer is formed over the metal oxide layer.

19. The method of claim 17, wherein the hafnium layer has a thickness of 50 Å or less.

20. The method of claim 16, wherein the reflective layer comprises silver.
